(19) United States
(12) Patent Application Publication
(10) Pub. No.: US 2026/0111000 A1
(43) Pub. Date: Apr. 23, 2026

(54) Method for Operating Cycle-Oriented Control Software

(71) Applicant: Siemens Aktiengesellschaft, Muenchen (DE)

(72) Inventors: Julia SCHWEIGER, Hirschau (DE); Sebastian SCHÖTZ, Hahnbach (DE); Markus WALTER, Bamberg (DE)

(21) Appl. No.: 19/363,944

(22) Filed: Oct. 21, 2025

(30) Foreign Application Priority Data
Oct. 22, 2024 (EP) 24207963

(51) Int. Cl. G05B 19/05

(52) U.S. Cl. CPC G05B 19/056; G05B 2219/1152; G05B 2219/13001; G05B 2219/14057; G05B 2219/15049

(57) ABSTRACT

A method for operating cycle-oriented control software for controlling processes, wherein the software executes within a runtime environment on a computer system and uses two independent time bases: a first time base derived from a hardware timer, and a second time base provided by a another timer is transmitted via a network communication, and the second time base is provided via telegrams with time stamps, where a receive routine assigns time stamps to a receipt time and stores them in a buffer, an evaluation routine recognizes and compensates interrupts that disrupt the safe time base, the past values of the first time base are stored in a cyclical buffer that an interrupt handler periodically updates, the evaluation routine checks the time differences between the telegrams and corrects the second time base if required, such that reliable and safe time measurement are ensured, even in the event of system management interrupts.

### BACKGROUND OF THE INVENTION

### 1. Field of the Invention

The invention relates to the specialized field of safety-oriented control systems, particularly in the form of software and relates, more particularly, to a method for operating cycle-oriented control software for controlling a process, where the control software is caused to execute within a runtime environment on a computer system, and use is made of a first time base, which is derived from a hardware timer of the computer system, and a further second time base, which is independent of the first time base, in order to provide a safe time base.

### 2. Description of the Related Art

Control systems today are conventionally based on a hardware platform, i.e., a special electronic substructure known as a programmable logic controller (PLC). Lately, when considering virtual control systems or software control systems, hardware is still required for their implementation, but the hardware can now be separated out completely. This means that the soft PLC as implemented no longer needs to know what device it is running on.

As previously, these devices can be dedicated control devices, such as multifunctional control platforms or industry PCs, or alternatively Edge computing platforms, these being found with increasing frequency in control networks of machine and plant operators, or even cloud computing platforms are used. Crucially, the hardware is separated out by via containers or hypervisors, on which containers the soft PLC is “deployed” (i.e., distributed or implemented) in standard ways, or orchestrated using tools, and it is no longer necessary to perform an installation as in the case of software-based control systems.

Programmable logic controllers must, in accordance with the requirements of the standard EN 61508, be configured so as to ensure functional safety. In the case of safety-related systems, such as programmable logic controllers for critical processes that include electrical, electronic or programmable electronic components and whose failure represents a significant risk to humans or the environment, these must be configure to ensure safety in particular. Examples of applications that demand heightened safety include the following: nuclear power stations, instrumentation for systems having safety-related significance, rail applications, telecommunication technology, signal technology and data processing systems, chemical processes, as well as small installations such as, for example, a pressroom machine for punching out metal panels.

EP 2 284 771 B1 and EP 2 241 953 B1 describe a safe time being formed from two timers (e.g., standard timer and failsafe timer or F-Timer) in each cycle. This is achieved by establishing the time difference between two cycles (S-Diff and F-Diff) and then comparing the time differences with a predetermined tolerance.

Until now, the implementation of the safe time has always been performed on a hardware base that was known to the user, with corresponding demands on the diversified timers. In the case of a conventional hardware CPU, two independent quartzes, i.e., a system quartz and a separate real-time RTC quartz are provided on the circuit board. In the case of a software CPU or hardware-independent control software, the PLC is executed on an unknown system.

Therefore, the unknown system must acquire a second time base from another reliable source. This occurs via network communication. Internal system management interrupts or other high-priority interrupts can occur on the unknown system. Consequently, the execution on the system can be disrupted and the acquisition of the second time base (receive routine), the transfer of the second clock cycle, and the access to the second time source may be affected, as a result of which the time stamp used in the programmable logic controller is not current.

In the event of a system management interrupt or other interrupt having a higher priority than a receive routine on the unknown system, the incoming data packets with the second time are not received.

### SUMMARY OF THE INVENTION

In view of the foregoing, it is an object of the invention to provide a method in which interrupts are compensated and consequently do not have any effect on the provision of the safe time base.

This and other objects and advantages are achieved in accordance with the invention by a method via which the second time base is derived from a network timer of a network component. The network component transmits time telegrams with a time stamp in a defined clock cycle.

A receive routine is invoked and, in this case, the received time telegrams with their time stamp are assigned to a receipt time and written into a time service buffer.

In addition, an evaluation routine is executed that recognizes interrupts of the computer system that could disrupt the provision of the safe time base. Here, the intension is to recognize interrupts that have an interrupt duration longer than the send clock cycle and that occur within a time segment before invocation of the evaluation routine, where past values of the time base are held in a cyclical buffer.

Applying a first periodicity, an interrupt handler incrementally changes an index and writes the first time base into the cyclical buffer with a number at a position specified by the index, where the first periodicity is selected such that at least those past values of the time base that came from the time segment before invocation of the evaluation routine are present in the cyclical buffer.

The evaluation routine checks whether the difference between the receipt time of the last time telegram and the receipt time of the penultimate time telegram is less than twice the send clock cycle, in which case program instructions are performed in the evaluation routine to correct the second time base because at least one time telegram must have been lost, and accordingly a time variance is calculated that is then added to the time stamp of the last recognized time telegram for the purpose of correction.

If a system management interrupt (SMI) occurs between the last and penultimate received data packets of a time telegram, the provision of the safe time base can be disrupted. In the event of a system management interrupt or other interrupt which has a higher priority than the receive routine, the incoming data packets with the second time base are not received. The quartzes or the timers, i.e., the actual hardware quartz and the quartz of the network component, are not affected by the SMIs, but the telegrams can be lost. For example, an interrupt affects the provision of the safe time in the following cases: (i) an SMI occurs between the last and penultimate received data packets that are evaluated, or (ii) an SMI occurs between the last received data packet and the evaluation routine.

Therefore the first periodicity (PZ1) is preferably selected such that an interrupt longer than an interrupt duration (TI) of the send clock cycle (ST) or of the send interval is recognized. In order to tolerate small jitters of the evaluation routine, a value smaller than the send clock cycle or send interval is preferably selected for the periodicity. In addition, a send tolerance window (STF) is also introduced. The following is relationship then given:

$$ZV = 2 * ( ST + STF )$$

$$len = ZV / PZ 1$$

If PZ1=0.8 ms, ST=1 ms and STF=1 ms, then a value is produced for len=5, which is rounded up to len=6.

Assuming that the time telegrams containing the second time base are transferred every 1 ms, the evaluation routine must recognize interrupts having a duration greater than or equal to 1 ms within a timespan of two time telegrams plus a send tolerance window. The recognition relates to interrupts that occurred before the invocation of the evaluation routine, 4 ms being derived from the dual send clock cycle+send tolerance window multiplied by two, because the last two time telegrams are evaluated.

Furthermore, the first periodicity must preferably be smaller than the send clock cycle, such that in the case of a send clock cycle of 1 ms a first periodicity of 0.8 ms is selected. A hardware quartz can then be read out, for example, every 0.8 ms and, for example, 64-bit values in ns can be entered into a cyclical buffer.

In other words, with regard to system management interrupts that could disrupt the safe time measurement, the solution consists in implementing a special routine. This routine recognizes system management interrupts that last longer than 1 ms and occur within 4 ms before the invocation of the evaluation routine. To this end, the routine reads the hardware quartz every 0.8 ms and stores the values in a cyclical buffer of 64-bit values over 4 ms to 4.8 ms before the evaluation routine. An index determines the position of the last entry in the cyclical buffer via a modulo calculation. The evaluation routine then performs calculations of the tolerances, in order to identify system management interrupts and include these in the further processing of the time signals. This method makes it possible to compensate, when providing the second time via a network communication, for the effects of system management interrupts, thereby increasing the reliability of the second time and/or the availability of the programmable logic controller. The inventive method has the advantage that, on unknown hardware, the virtualized system that receives the second time via a network communication for the purpose of forming a safe time base becomes insensitive to system management interrupts or high-priority interruptions that cannot be controlled or turned off. The new solution allows a flexible and hardware-independent implementation of safe time functions. In a further embodiment, the evaluation routine specifies an end and a beginning of a relevant range for the interrupt within the cyclical buffer, for which purpose possible interrupts are initially disabled via a first instruction and, while they are disabled, the following are performed in a second instruction block: the first time base is read from the hardware timer, the index is read, the values from the cyclical buffer are copied into a temporary cyclical buffer, the first time base having been read is copied into the temporary cyclical buffer at the first position, possible interrupts are then enabled again via a third instruction, in a fourth instruction the time variance that must be calculated between the time stamp of the last time telegram and the time stamp of the penultimate time telegram is set to zero, if following thereupon at a first branch point the evaluation routine recognizes that the difference between the receipt time of the last time telegram and the receipt time of the penultimate time telegram is less than twice the send clock cycle, and a difference between the time stamp of the last time telegram and the time stamp of the penultimate time telegram is less than twice the send clock cycle, then the time variance is not recalculated, otherwise the time variance is recalculated in a first case specification.

The time variance is advantageously determined in the first case specification as follows: (i) a first range is initially established for the calculation of the time variance, to which end an upper limit is ascertained in the temporary cyclical buffer, a check being performed to determined, starting with the highest position, whether the respective entry is greater than the value of the receipt time of the last recognized time telegram, in which case the upper limit is established, a lower limit is then ascertained in the temporary cyclical buffer, a checked being performed to determined, starting with the lowest position, whether the respective entry is smaller than the value of the receipt time of the penultimate recognized time telegram, in which case the lower limit is established, and (ii) secondly, the value of the upper limit and the value of the lower limit are subtracted from each other and if the difference is greater than the send clock cycle, then the first periodicity is subtracted from the difference and the remainder is added to the time variance.

The upper limit and the lower limit constitute an interval. The difference between adjacent time stamps is ascertained within the determined interval and, for example, a difference of more than 1,000 microseconds indicates the existence of SMIs.

The inventive method allows the intervals to be specified precisely, even at varying data speeds. The flexible handling of the time stamp differences advantageously ensures that anomalies are recognized more reliably, thereby resulting in greater accuracy and reliability of the interval specification and significantly improving the industrial applicability of the method. The combination of these features results in an improved technical effect that extends beyond the mere addition of present improvements.

Following thereupon, at a second branch point, a check is performed to determine whether the difference between the first time base which has been read, which thus corresponds to the invocation time point of the evaluation routine, and the receipt time of the last time telegram is less than twice the send clock cycle, in which case a time separation is not recalculated, otherwise the time separation is recalculated, said time separation being derived from the difference between the receipt time of the last time telegram and the receipt time of the penultimate time telegram.

The time separation is calculated in a second case specification, where the following procedure is applied from the receipt time of the last time telegram to the receipt time of the penultimate time telegram in the second case scenario: (i) a second range is initially established for the calculation of the time separation, to which end an upper limit is established in the temporary cyclical buffer as the lowest position, a lower limit is ascertained in the temporary cyclical buffer, a check being performed to determined, starting with the lowest position, whether the respective entry is smaller than the value of the receipt time of the last recognized time telegram, in which case the lower limit is established, and (ii) secondly, the value of the upper limit and the value of the lower limit are subtracted from each other and if the difference is greater than the send clock cycle, then the first periodicity is subtracted from the difference and the remainder is added to the time separation.

Four controls are advantageously performed for the purpose of establishing the ranges and for the calculations, (i) a first control, in which checked is performed to determined whether the difference between the receipt time of the last time telegram and the receipt time of the penultimate time telegram is less than twice the send clock cycle, (ii) a second control, in which checked is performed to determined whether the difference between the receipt time and the first time base which has been read at the first position in the temporary cyclical buffer is less than twice the send clock cycle, (iii) a third control, in which in which checked is performed to determined whether the difference between the time stamp of the last time telegram and the time stamp of the penultimate time telegram is greater than zero, and (iv) a fourth control, in which in which checked is performed to determined whether the difference between the time stamp of the last time telegram and the time stamp of the penultimate time telegram is less than twice the send clock cycle, such that the recognition of an interrupt can be divided into three cases, specifically a first case, a second case and a third case.

As a further protection when providing the safe time, a first time difference is produced from the first time base of the current cycle and the first time base of the preceding cycle, and a second time difference is produced from the second time base of the current cycle and the second time base of the preceding cycle, a comparison is made between the time differences and a predetermined tolerance, and an error signal is generated if the variation between the time differences exceeds the tolerance.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in greater detail below with reference to an exemplary embodiment in the drawing, in which:

FIG. 1 shows a computer system for operating cycle-oriented control software;

FIG. 2 shows a schematic illustration of the invocation of an evaluation routine;

FIG. 3 shows an example of the invocation of a time function that invokes evaluation routines;

FIG. 4 shows a program sequence of the evaluation routine;

FIG. 5 shows a case differentiation for recognizing an interrupt; and

FIG. 6 shows a temporal sequence of time telegrams with a disruptive interrupt.

### DETAILED DESCRIPTION OF THE EXEMPLARY EMBODIMENTS

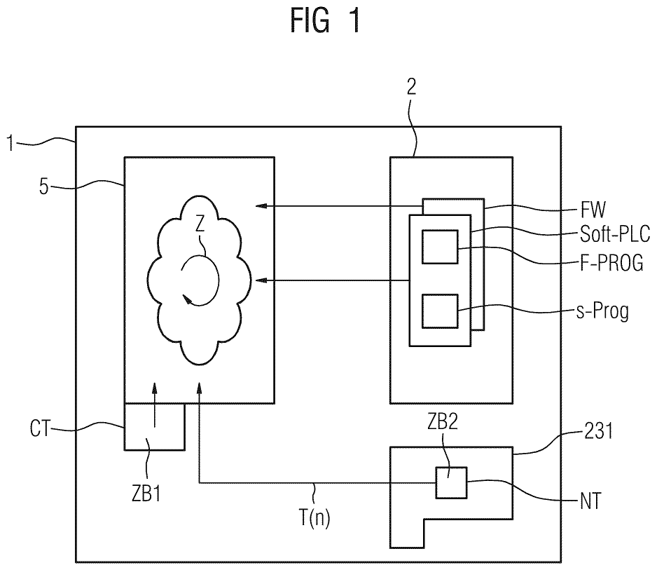

Shown in FIG. 1 is a computer system 1 comprising a processor 5 with a system time, i.e., a hardware timer. The computer system 1 can take the form of any desired IT infrastructure, such as an industry PC, an Edge computer platform or a cloud computing platform, for example. The computer system 1 has a storage area 2 in which a runtime environment FW and control software Soft-PLC is loaded, this comprising a safety program F-Prog and a standard program S-Prog. The user can program their own instructions into the standard program S-Prog.

In the processor 5, the system time and a safety time are used and evaluated with a cycle Z when executing the control software Soft-PLC with the safety program F-Prog.

The control software Soft-PLC is therefore stored in the storage area 2 and made to execute cyclically Z in the processor 5 for the failsafe control of automation routines of a process.

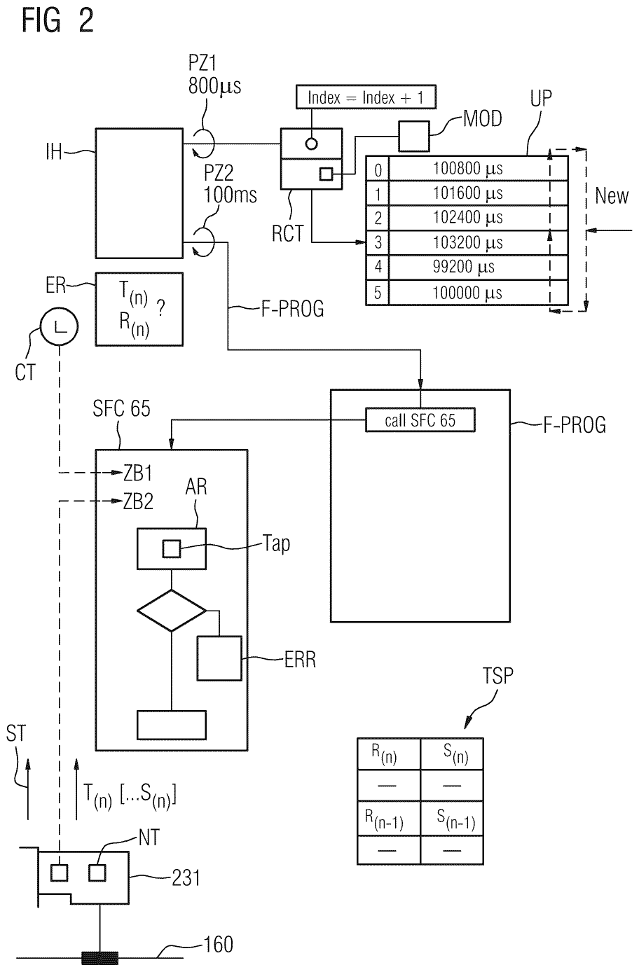

Shown in FIG. 2 is a schematic illustration of the invocation of an evaluation routine AR. The method for operating the cycle-oriented control software Soft-PLC, where control software Soft-PLC is made to execute within the runtime environment FW on the computer system 1, inventively relates to the provision of a safe time base, where use is made of a first time base ZB1, specifically the system time from FIG. 1, derived from a hardware timer CT of the computer system 1, and a further second time base ZB2, specifically the safety time, which is independent of the first time base ZB1.

The second time base ZB2 is sent from a network card 231 in a send clock cycle ST, via time telegrams T(n) with a time stamp S(n), to a time module SFC65, said time module SFC65 also containing the evaluation routine AR. The hardware timer CT provides the time module SFC65 with the first time base ZB1 likewise. Every 800 ms, i.e., applying a first periodicity PZ1, an interrupt handler IH invokes a save routine in order to store past values of the time base ZB1 in a cyclical buffer UP.

In accordance with the invention, the past values of the time base ZB1 are held in the cyclical buffer UP. Applying the first periodicity PZ1, the interrupt handler IH incrementally increases an index Index, and the first time base ZB1 is written into the cyclical buffer UP with a number len at a position i that is specified by the index Index. The first periodicity PZ1 is selected such that at least those past values of the time base ZB1 that came from the time segment before invocation of the evaluation routine AR are present in the cyclical buffer UP.

The object of the evaluation routine AR is to recognize interrupts having high priority or SMIs of the computer system 1 that could disrupt the provision of the safe time base. It is intended to recognize interrupts that have an interrupt duration TI greater than the send clock cycle ST and that occur within the time segment before invocation of the evaluation routine AR.

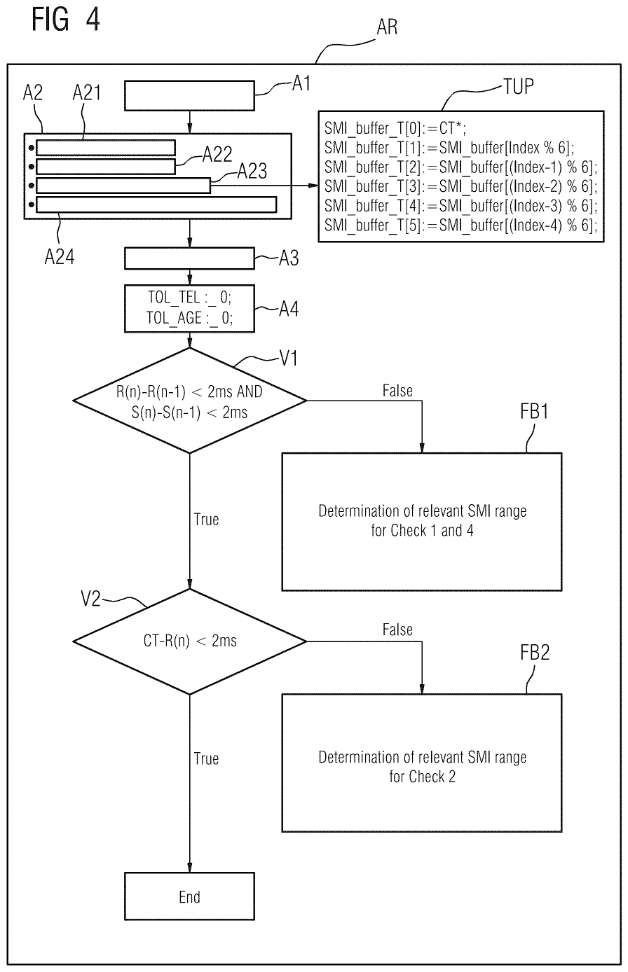

The interrupt handler IH, applying a second periodicity PZ2 of 100 ms, invokes the safety program F-Prog in each case. At the start of the safety program F-Prog, the time module SFC65 for providing the safe time base SB is invoked. The first time base ZB1 and the second time base ZB2 are available in the time module SFC65. The evaluation routine AR is then invoked. The precise sequence of the evaluation routine AR is illustrated in FIG. 4. A receive routine ER is formed as a Linux thread, for example, and is invoked as soon as a time telegram T(n) arrives. When a time telegram T(n) is received by the receive routine ER, it saves the corresponding time stamp S(n) in a time service buffer TSP. A receipt time R(n) of the last time telegram T(n) and a receipt time R(n−1) of the penultimate time telegram T(n−1) are saved correspondingly. A time stamp S(n) of the last time telegram T(n) and a time stamp S(n−1) of the penultimate time telegram T(n−1) are also saved. In the safety program F-Prog, the time module SFC65 is always invoked first and, following the invocation of the time module SFC65, the safety program F-Prog and a user program S-Prog are processed.

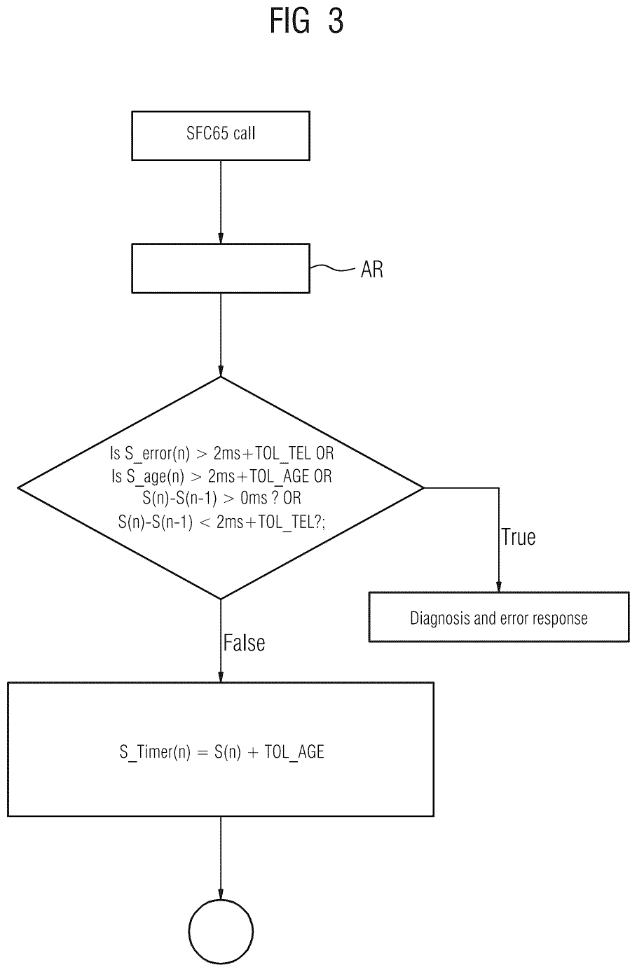

Shown in FIG. 3 is a program sequence within the time module SFC65. After the time module SFC65 has been invoked, the evaluation routine AR is invoked, in which checked is performed to ascertain whether the determined second time base ZB2 was possibly disrupted by interrupts, and a correction value is then calculated in the evaluation routine AR accordingly. A correction value is provided in the form of time variance TOL_TEL. The evaluation routine AR returns the time variance TOL_TEL and a time separation TOL_AGE accordingly. Using these returned values, the time module SFC65 can then check whether the safe time base can still be provided.

FIG. 4 shows a program sequence plan of the evaluation routine AR. The evaluation routine AR is executed in order to determine whether interrupts SMI of the computer system 1 could possibly disrupt the provision of the safe time base. These possible disruptions can be recognized via the evaluation routine AR. The evaluation routine AR specifies an end and a beginning of a range B1,B2, which is relevant for the interrupt SMI, within the cyclical buffer UP. With a first instruction A1, the evaluation routine AR disables possible interrupts SMI. While the interrupts SMI are disabled, the following steps are performed via a second instruction block A2.

In a first step A21 the first time base ZB1 is read from the hardware timer CT, in a next step A22 the index Index is read, in a third step A23 the values from the cyclical buffer UP are copied into a temporary cyclical buffer TUP, and in a fourth step A24 the first time base ZB1 having been read is copied into the temporary cyclical buffer TUP at the first position i=0. With a third instruction A3, possible interrupts SMI are enabled again. With a fourth instruction A4, the time variance TOL_TEL that must be calculated and the time separation TOL_AGE are set to zero.

At a first branch point V1, a check is now performed to determine whether the difference between the receipt time R(n) of the last time telegram T(n) and the receipt time R(n−1) of the penultimate time telegram T(n−1) is less than twice the send clock cycle ST and a check is additionally performed to determine whether a difference between the time stamp S(n) of the last time telegram T(n) and the time stamp S(n−1) of the penultimate time telegram T(n−1) is less than twice the send clock cycle ST. If this is the case, then the time variance TOL_TEL is not recalculated. If this is not the case, then the time variance TOL_TEL is recalculated in a first case specification FB1.

In the first case specification FB1, the time variance TOL_TEL is calculated as follows. A first range B1 is initially established for the calculation of the time variance TOL_TEL, to which end an upper limit is ascertained in the temporary cyclical buffer TUP, where a check is performed to determine, starting with the highest position, whether the respective entry is greater than the value of the receipt time R(n) of the last recognized time telegram T(n). If this is the case, then the upper limit is established.

A lower limit is ascertained in the temporary cyclical buffer TUP as follows: starting with the lowest position, a check is performed to determine whether the respective entry is smaller than the value of the receipt time R(n−1) of the penultimate recognized time telegram T(n−1). If this is the case, then the lower limit is established.

Secondly, the value of the upper limit and the value of the lower limit are subtracted from each other and if the difference is greater than the send clock cycle ST=1 ms, then the first periodicity PZ1=800 μs is subtracted from the difference and the remainder is added to the time variance TOL_TEL as a correction.

At a second branch point V2, a check is then performed to determine whether the difference between the first time base ZB1 that has been read, which thus corresponds to the invocation time point of the evaluation routine AR, and the receipt time R(n) of the last time telegram T(n) is less than twice the send clock cycle ST=2 ms. If this is the case, then the first time separation TOL_AGE is not recalculated. For a recalculation of the time separation TOL_AGE, the difference between the receipt time R(n) of the last time telegram T(n) and the receipt time R(n−1) of the penultimate time telegram T(n−1) is used.

In a second case specification FB2, an upper limit and a lower limit are also determined. Here, a second range is initially established for the calculation of the time separation TOL_AGE, to which end an upper limit in the temporary cyclical buffer TUP is established as the lowest position. A lower limit in the temporary cyclical buffer TUP is ascertained by checking whether, starting with the lowest position, the respective entry is smaller than the value of the receipt time R(n) of the last recognized time telegram T(n). If this is the case, then the lower limit is established.

Secondly, the value of the upper limit and the value of the lower limit are subtracted from each other and if the difference is greater than the send clock cycle ST, then the first periodicity PZ1 is subtracted from the difference and the remainder is added to the time separation TOL_AGE.

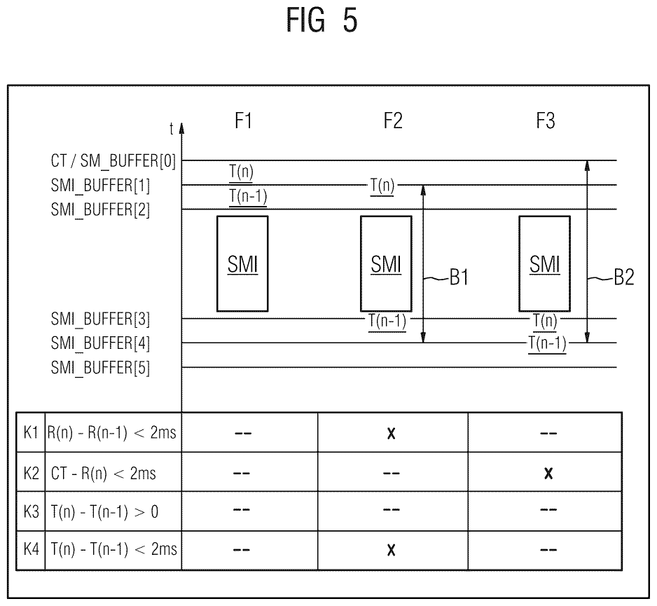

FIG. 5 shows three cases for recognizing an interrupt SMI, specifically a first case F1, a second case F2 and a third case F3. Four controls K1, . . . . K4 are implemented for the calculation of the range definition B1, B2 and for the calculations of the time variances TOL_TEL or the time separations TOL_AGE. In a first control K1, a check is performed to determine whether the difference between the receipt time R(n) of the last time telegram T(n) and the receipt time R(n−1) of the penultimate time telegram T(n−1) is less than twice the send clock cycle ST. In a second control K2, a check is performed to determined whether the difference between the receipt time R(n) and the first time base ZB1 that has been read at the first position in the temporary cyclical buffer TUP is less than twice the send clock cycle ST. In a third control K3, a check is performed to determine whether the difference between the time stamp S(n) of the last time telegram T(n) and the time stamp S(n−1) of the penultimate time telegram T(n−1) is greater than zero. In a fourth control K4, a check is performed to determine whether the difference between the time stamp S(n) of the last time telegram T(n) and the time stamp S(n−1) of the penultimate time telegram T(n−1) is less than twice the send clock cycle ST. The recognition of an interrupt SMI can therefore be divided into three cases, specifically the first case F1, the second case F2 and the third case F3. According to the first case F1, everything ran smoothly and a time telegram T(n) was not disrupted. In the second case F2, the first control K1 and the second control K4 are positive, and a substitute time must therefore be specified. In the third case F3, the second control K2 is positive and a substitute time must be calculated.

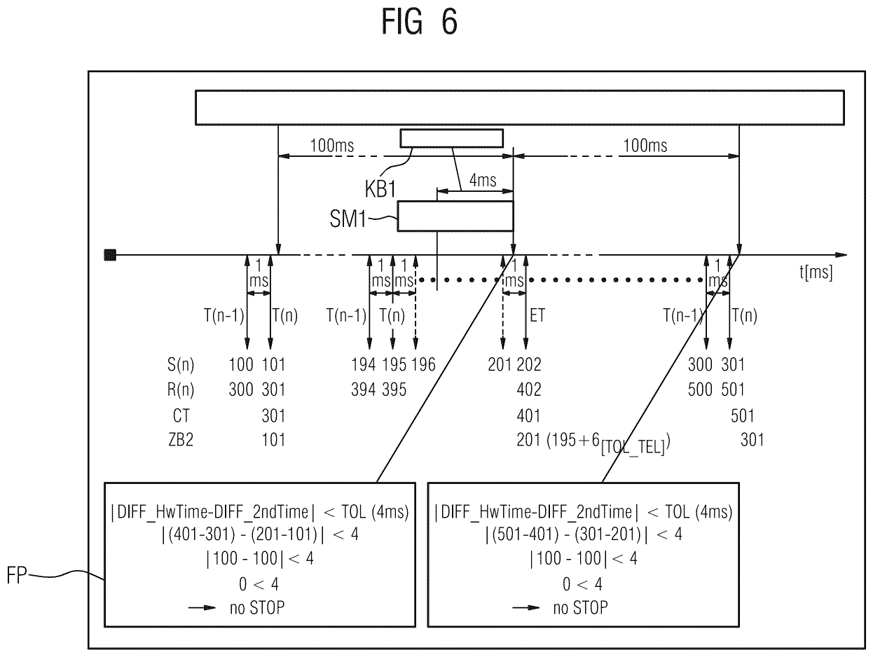

FIG. 6 illustrates the temporal receipt of time telegrams T(n) and T(n−1) over a time line. A critical range KPI for interrupts is illustrated, where a time telegram T(n) could be engulfed. A possible system management interrupt SMI that would disrupt the receipt of telegrams from the receive routine ER is marked. One row shows the count values for the time stamp S(n) from the network communication, one row shows the receipt time R(n), one row shows the first time base ZB1 from the hardware timer CT, and the last row shows the second time base ZB1. At the point where it is marked, the system management interrupt SMI would engulf the time telegram T(n) having the time count 196. The following five other time telegrams up to the time count 201 would also be engulfed. The system management interrupt SMI then comes to an end and the next time telegram T(n) having the time count 201 becomes visible again. However, the last time count 195 before the appearance of the system management interrupt SMI appeared is still in the memory. The evaluation routine AR now ensures that six time counts are added to the last time count 195, thereby arriving once again at a time count of 201.

In summary, the invention relates to a method for operating cycle-oriented control software (Soft-PLC) for controlling processes. This software executes within a runtime environment on a computer system and uses two independent time bases: a first time base that is derived from a hardware timer, and a second time base that is provided by a timer that is independent from the hardware timer and that is transmitted via a network communication. The second time base is provided via time telegrams with time stamps. A receive routine assigns these time stamps to a receipt time and stores them in a buffer. An evaluation routine recognizes and compensates interrupts that could disrupt the provision of the safe time base. The past values of the first time base are stored in a cyclical buffer. An interrupt handler periodically updates this buffer. The evaluation routine checks the time differences between the telegrams and corrects the second time base if required. The inventive method ensures reliable and safe time measurement, even in the event of system management interrupts.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for operating cycle-oriented control software for controlling a process, the control software being executed within a runtime environment on a computer system, a first time base, which is derived from a hardware timer of the computer system, and a further second time base, which is independent of the first time base being utilized to provide a safe time base, and the second time base being derived from a network timer of a network component, the method comprising:
sending, by the network component time telegrams with a time stamp in a send clock cycle;
invoking a receive routine when a time telegram arrives, and assigning the time telegrams with associated respective time stamps to a receipt time and writing the time telegrams into a time service buffer;
executing an evaluation routine to recognize interrupts of the computer system which could disrupt provision of the safe time base, such that interrupts having an interrupt duration greater than a send clock cycle and which occur within a time segment before invocation of the evaluation routine are recognized;
holding past values of the time base in a cyclical buffer;
applying a first periodicity, and incrementally changing, by an interrupt handler, an index and writing the first time base into the cyclical buffer with a number at a position specified by the index, the first periodicity being selected such that at least those past values of the time base which came from the time segment before invocation of the evaluation routine are present in the cyclical buffer; and
checking, by the evaluation routine, whether a difference between the receipt time of a last time telegram and a receipt time of a penultimate time telegram is less than twice the send clock cycle, program instructions being performed in the evaluation routine to correct the second time base caused by at least one time telegram being lost, and calculating a time variance is calculated which is subsequently added to the time stamp of a last recognized time telegram to provide a correction.

2. The method as claimed in claim 1, wherein the evaluation routine specifies an end and a beginning of a relevant range for an interrupt within the cyclical buffer, possible interrupts being are initially disabled via a first instruction and while the possible interrupts are disabled, the method further comprising in a second instruction block:
reading the first time base from the hardware timer;
reading the index;
copying values from the cyclical buffer into a temporary cyclical buffer;
copying the first time base which is read into the temporary cyclical buffer at a first position;
reenabling possible interrupts via a third instruction;
setting, in a fourth instruction, the time variance which must be calculated between the time stamp of the last time telegram and the time stamp of the penultimate time telegram to zero, if following thereupon at a first branch point the evaluation routine recognizes that:
(i) the difference between the receipt time of the last time telegram and the receipt time of the penultimate time telegram is less than twice the send clock cycle; and
(ii) a difference between the time stamp of the last time telegram and the time stamp of the penultimate time telegram is less than twice the send clock cycle, the time variance is not recalculated, otherwise
(iii) the time variance is recalculated in a first case specification.

3. The method as claimed in claim 2, wherein the time variance is determined in a first case specification in which:
a first range is initially established for the calculation of the time variance, an upper limit being ascertained in the temporary cyclical buffer, and starting with a highest position, a check is performed to determined whether a respective entry is greater than a value of the receipt time of a last recognized time telegram, such that an upper limit is established, a lower limit being subsequently ascertained in the temporary cyclical buffer, and starting with a lowest position, a check being performed to determine whether the respective entry is smaller than the value of the receipt time of the penultimate recognized time telegram, such that the lower limit is established; and
the value of the upper limit and the value of the lower limit are secondly subtracted from each other and the first periodicity is subtracted from the difference and a remainder is added to the time variance if the difference is greater than the send clock cycle.

4. The method as claimed in claim 2, wherein at a second branch point a check is performed to determine whether the difference between the first time base which has been read, which thus corresponds to the invocation time point of the evaluation routine, and the receipt time of the last time telegram is less than twice the send clock cycle, in which case a time separation is not recalculated, otherwise the time separation is recalculated; and wherein the time separation is derived from the difference between the receipt time of the last time telegram and the receipt time of the penultimate time telegram.

5. The method as claimed in claim 3, wherein at a second branch point a check is performed to determine whether the difference between the first time base which has been read, which thus corresponds to the invocation time point of the evaluation routine, and the receipt time of the last time telegram is less than twice the send clock cycle, in which case a time separation is not recalculated, otherwise the time separation is recalculated; and wherein the time separation is derived from the difference between the receipt time of the last time telegram and the receipt time of the penultimate time telegram.

6. The method as claimed in claim 4, wherein the time separation from the receipt time of the last time telegram to the receipt time of the penultimate time telegram is determined in a second case specification in which:
a second range is initially established for calculation of the time separation, an upper limit being established in the temporary cyclical buffer (TUP) as a lowest position, and a lower limit being ascertained in the temporary cyclical buffer, and starting with the lowest position, a check is performed to determine whether a respective entry is smaller than a value of the receipt time of a last recognized time telegram, such that the lower limit is established; and
the value of the upper limit and the value of the lower limit are subsequently subtracted from each other, the first periodicity being subtracted from the difference and a remainder being added to the time separation if the difference is greater than the send clock cycle.

7. The method as claimed in claim 3, wherein four controls are performed to establish ranges and for the calculations:
a first control, in which a check is performed to determine whether the difference between the receipt time of the last time telegram and the receipt time of the penultimate time telegram is less than twice the send clock cycle;
a second control, in which a check is performed to determine whether the difference between the receipt time and the first time base which has been read at the first position in the temporary cyclical buffer is less than twice the send clock cycle;
a third control, in which a check is performed to determine whether the difference between the time stamp of the last time telegram and the time stamp of the penultimate time telegram is greater than zero; and
a fourth control, in which a check is performed to determine whether the difference between the time stamp of the last time telegram and the time stamp of the penultimate time telegram is less than twice the send clock cycle;
wherein the recognition of the interrupt being dividable into three cases comprising a first case, a second case and a third case.

8. The method as claimed in claim 4, wherein four controls are performed to establish ranges and for the calculations:
a first control, in which a check is performed to determine whether the difference between the receipt time of the last time telegram and the receipt time of the penultimate time telegram is less than twice the send clock cycle;
a second control, in which a check is performed to determine whether the difference between the receipt time and the first time base which has been read at the first position in the temporary cyclical buffer is less than twice the send clock cycle;
a third control, in which a check is performed to determine whether the difference between the time stamp of the last time telegram and the time stamp of the penultimate time telegram is greater than zero; and
a fourth control, in which a check is performed to determine whether the difference between the time stamp of the last time telegram and the time stamp of the penultimate time telegram is less than twice the send clock cycle;
wherein the recognition of the interrupt being dividable into three cases comprising a first case, a second case and a third case.

9. The method as claimed in claim 6, wherein four controls are performed to establish ranges and for the calculations:
a first control, in which a check is performed to determine whether the difference between the receipt time of the last time telegram and the receipt time of the penultimate time telegram is less than twice the send clock cycle;
a second control, in which a check is performed to determine whether the difference between the receipt time and the first time base which has been read at the first position in the temporary cyclical buffer is less than twice the send clock cycle;
a third control, in which a check is performed to determine whether the difference between the time stamp of the last time telegram and the time stamp of the penultimate time telegram is greater than zero; and
a fourth control, in which a check is performed to determine whether the difference between the time stamp of the last time telegram and the time stamp of the penultimate time telegram is less than twice the send clock cycle;
wherein the recognition of the interrupt being dividable into three cases comprising a first case, a second case and a third case.

10. The method as claimed in claim 1, wherein a first time difference is produced from the first time base of a current cycle and the first time base of a preceding cycle, and a second time difference is produced from the second time base of the current cycle and the second time base of the preceding cycle, a comparison being made between the first and second time differences and a predetermined tolerance, and an error signal being generated if a variation between the first and second time differences exceeds the predetermined tolerance.
